(19) United States
(12) Patent Application Publication
(10) Pub. No.: US 2012/0299735 A1
(43) Pub. Date: Nov. 29, 2012

(54) METHODS AND SYSTEMS FOR MEASURING A NUMBER OF LAYERS OF A MULTILAYER MATERIAL

(76) Inventors: David B. Smith, Boynton Beach, FL (US); Jeffrey Ortiz, Hallandale Beach, FL (US); Charles Taylor, Pompano Beach, FL (US); Jun Seok Lee, Weston, FL (US); Brandon Williamson, Elkton, MD (US)

(21) Appl. No.: 13/116,693

(22) Filed: May 26, 2011

(51) Int. Cl. G08B 17/12; G01T 1/34

(52) U.S. Cl. 340/600; 250/395; 250/393

(57) ABSTRACT

Methods and corresponding systems are provided for determining a ply count of a multilayer material is provided that includes: placing the multilayer material between an emitter and a detector of a gauge; emitting at least one pulse of ionized radiation from a source associated with the emitter; detecting a number of particles emitted from the emitter passing through the multilayer material placed between the emitter and the detector; and translating the number of particles detected into a ply count using a computing device.

### BACKGROUND

The present application relates to methods and systems for measuring a multilayer article and more particularly methods and systems for measuring the number of layers of a multilayer article.

Multilayer articles are used in a variety of applications, including the manufacture of body armor. The number of layers of the material used in body armor affects or is otherwise determinative of the performance and quality of a ballistic protective garment. Currently, a few ways exist to determine whether ballistic packages have the desired number of layers of a material. Ballistics packages, for example, can be weighed, counted by hand, or a combination of these methods to determine ply count accuracy. All of these methods, however, have significant disadvantages relating to precision and reliability. With regard to weight, scales can be very reliable with larger components, but less reliable when used on smaller components. Specifically, one ply of a relatively small component can weigh only 2 grams, but the variation in the weight of 34-37 plies of the can differ as much as 2 grams difference. Counting the number of ballistic ply layers present in the vests by hand, in addition to being resource intensive, relies on the reliability of a technician over relatively long periods. It is not uncommon for a single operator, in an eight-hour shift, to actually count by hand to verify up to 20,400 individual ballistic plies in a single shift, which makes manually counting plies prone to human error. Accordingly, there is a need for methods and for determining and/or verifying the number of plies present in a ballistic package that are not so limited.

### SUMMARY

In at least one aspect of the disclosure, a method for determining a ply count of a multilayer material is provided that includes: placing the multilayer material between an emitter and a detector of a gauge; emitting at least one pulse of ionized radiation from a source associated with the emitter; detecting a number of particles emitted from the emitter passing through the multilayer material placed between the emitter and the detector; and translating the number of particles detected into a ply count using a computing device.

In at least one embodiment, the multilayer material comprises a plurality of layers of ballistic material.

In at least one embodiment, the source comprises Strontium.

In at least one embodiment, the emitter comprises at least 0.5 millicurie of Strontium.

In at least one embodiment, the emitter emits radiation in a range of about 1000 to about 8000 g/m².

In at least one embodiment, the method includes calibrating the gauge at least initially against one or more samples of a multilayer material having a known number of plies and storing calibration data comprising at least one of a set point, and an upper and lower control limit associated with the one or more samples.

In at least one embodiment, the method includes, for each of a plurality of lots of multilayer materials being tested, calibrating the gauge further by testing a set of samples from each of the lots against the initial calibration and storing calibration data comprising at least one of a set point, and an upper and lower control limit associated with the set of samples.

In at least one embodiment, the method includes determining that the multilayer material being tested is at least one of missing at least one ply, includes an extra ply, and includes a partial ply.

In at least one embodiment, the method includes displaying at least one of a visual and an audio indication that the material being tested has failed a test.

In at least one embodiment, the emitter comprises at least 0.5 millicurie of Strontium and wherein the emitter and detector are located from about 1 inch to about 4 inches from each other.

In at least one aspect of the disclosure, a system is provided for determining a ply count of a multilayer material that includes: an emitter operable to emit at least one pulse of ionized radiation from a source associated with the emitter; a detector operable to detect a number of particles emitted from the emitter passing through the multilayer material placed between the emitter and the detector; and a computing device coupled to at least the detector, the computing device operable to translate the number of particles detected into a ply count.

In at least one embodiment, the multilayer material comprises a plurality of layers of ballistic material.

In at least one embodiment, the emitter comprises at least 0.5 millicurie of Strontium and wherein the emitter and detector are located from about 1 inch to about 4 inches from each other.

In at least one embodiment, the emitter emits radiation in a range of about 1000 to about 8000 g/m².

In at least one embodiment, the system includes a database including calibration data comprising at least one of a set point, and an upper and lower control limit associated with one or more samples of a multilayer material having a known number of plies, the computing device operable to translate the number of particles detected into a ply count based on the calibration data.

In at least one embodiment, the database further includes calibration data for a set of samples of a lot of multilayer materials being tested, the calibration data comprising at least one of a set point, and an upper and lower control limit associated with the set of samples, the computing device is operable to translate the number of particles detected into a ply count based on the calibration data associated with the set of samples of the lot.

In at least one embodiment, the computing device is operable to determine that the multilayer material being tested is at least one of missing at least one ply, includes an extra ply, and includes a partial ply.

In at least one embodiment, the computing device is operable to display at least one of a visual and an audio indication that the material being tested has failed a test.

In at least one aspect of the disclosure, a system is provided for determining a ply count of a multilayer ballistic material that includes: an emitter operable to emit at least one pulse of ionized radiation from a source associated with the emitter, wherein the emitter comprises at least 0.5 millicurie of Strontium; a detector operable to detect a number of particles emitted from the emitter passing through the multilayer ballistic material placed between the emitter and the detector, and wherein the emitter and detector are located from about 1 inch to about 4 inches from each other; a database comprising: a first set of calibration data comprising at least one of a set point, and an upper and lower control limit associated with one or more samples of the multilayer material having a known number of plies, and a second set of calibration data for a set of samples of a lot of multilayer materials being tested, the calibration data comprising at least one of a set point, and an upper and lower control limit associated with the set of samples; and a computing device coupled to at least the detector, the computing device operable to translate the number of particles detected into a ply count based on the first set of calibration data and the second set of calibration data, determine therefrom that the multilayer material being tested is at least one of missing at least one ply, includes an extra ply, and includes a partial ply, and display at least one of a visual and an audio indication that the material being tested has either failed a test.

Additional aspects will be apparent in view of the description which follows.

### BRIEF DESCRIPTION OF THE FIGURES

FIG. 1 is a flow diagram of a method for measuring the number of layers of a multilayer article according to one embodiment of the methods disclosed; and

FIG. 2 is a block diagram of a system for measuring the number of layers of a multilayer article according to one embodiment of the systems disclosed.

### DETAILED DESCRIPTION OF THE INVENTION

The present application generally provides methods and system for measuring the number of layers of a multilayer article. Although the methods and system of the present application may be discussed by way of example in relation to body armor and ballistic packages, it is understood that the methods and system disclosed herein may be used to measure the number of layers in other multilayer articles. Therefore, the methods and system of the present application may be used to measure the number of layers or plies of a ballistic, non-ballistic materials, and/or a combination thereof, including sheets of woven fibers and/or laminates of aramid, glass, graphite, carbon, nylon, polyester, cotton, wool, metal, etc., as well as non-woven/laminated layers of materials.

A body armor ballistics package assembly consists of multiple layers or plies of an energy absorbing “pad” of aramid material. This ballistic assembly is configured in such a way as to absorb the energy generated by a high-speed projectile and prevent that projectile from penetrating, for example, the human body. The key to the successful neutralization of a 22 to 50-caliber projectile, for instance, is to tailor the density and/or energy absorption properties of the pad and/or the ballistic package with the desired number of plies of the material or materials. A particular ballistic garment may include a plurality of ballistic packages each having a different ply count or density, energy absorbing properties and/or other performance characteristics. For example, a vest may include a package located in a first area of the vest that has different properties than another area of the vest. Ballistic packages for different types of garments may differ similarly. The varying properties may be as a result of using different materials and/or different ply counts in each of the packages. A first package, for instance, may include a first base material having a first base ply count and a first ballistic material having a first ballistic ply count, whereas a second package may include a second base material having a second base ply count and a second ballistic material having a second ballistic ply count. In this example, the differences between the two packages can generally be described as at least one of the first variables of the first package not being the same as the corresponding second variables of the second package.

In at least one embodiment of the methods and systems disclosed herein, the number of plies of a material in a ballistic package is measured or otherwise determined using a beta gauge to detect the ply density or count of the ballistic package and determine therefrom whether the package is missing one or more plies, or includes extra or partial plies of one or more of the materials used therein. This allows an operator of the gauge to test ballistic packages that use multiple layers of various brands and types of the ballistic, non-ballistic materials, or combinations thereof used in the manufacture of protective ballistic garments.

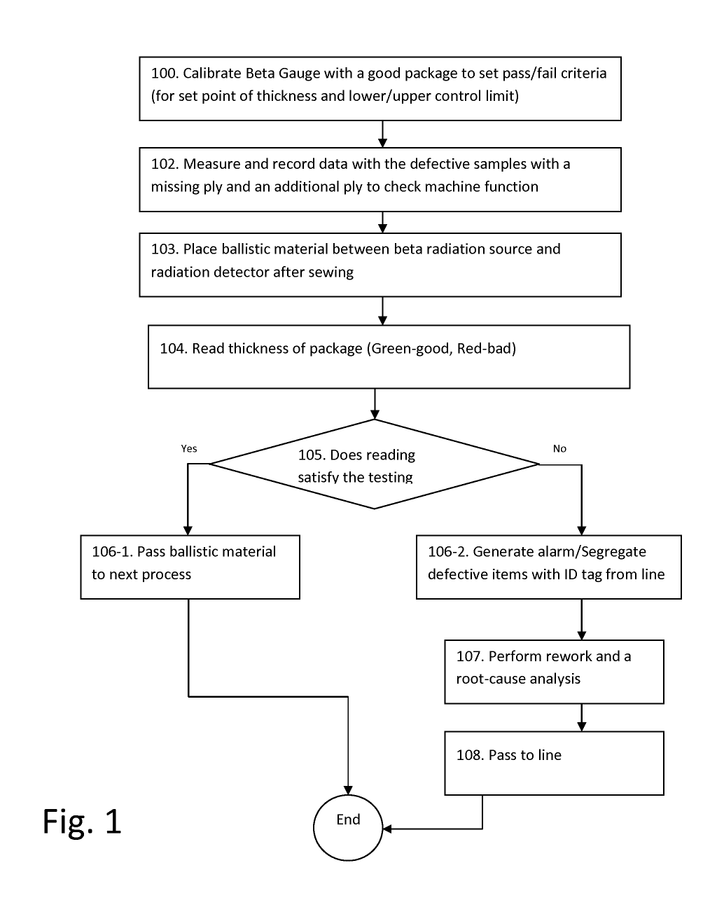

Referring to FIG. 1, in at least one embodiment, a process for measuring the number of plies of a multiple layer material begins by calibrating a beta gauge with one or more packages having a known number of ply counts or ply density at 102. The calibration data of the one or more packages having a known number of ply counts and/or density may be stored in a database with information identifying a particular package associated with the calibration data. For example, with reference to the vest example discussed above, the first and second packages may each be identified with a unique ID and the ply reading for each may be associated in the database with each of the IDs. The ply reading itself may be represented various ways. For example, the ply reading may be a specific reading or a range or readings, as well as a plurality of readings at different areas of the package. The range may be used to define pass/fail criteria for a particular package. That is, a package that fall's within the defined range passes whereas one that fall's outside of the range fails.

After the initial calibration of a particular package, additional calibration may be performed on a lot by lot basis for each of a plurality of lots being produced. That is, a first set of samples, such as 10 or more, may be selected from a given lot and tested using the beta gauge by placing the samples between an emitter and a detector of the beta gauge and obtaining a measurement therefrom, whether numerical, pass/fail, or otherwise. When the operator places the ballistic package in the beta gauge, any air bubbles or gaps between plies are preferably removed before taking any readings. The process of removing gaps between plies maybe performed manually with the operator carefully sweeping his or her hand over the package or automatically with the beta gauge. Thereafter, the operator reads and records the ply reading for each of the samples. In at least one embodiment, the operator only records readings for samples that pass (green signal) when compared to the readings associated with the original or a previous calibration until the desired number of samples of the lot are tested. After collecting the desired amount of data, the operator may average the readings to determine a set point for the lot and may add a suitable range representing , e.g., ±about 200 mg/cm² for a control limit, which may be proven based on statistical analysis.

In addition or in the alternative to calibrating the system using packages having a desired number of acceptable ply counts and/or density, the system may be calibrated in order to be able to identify defective samples. That is, the gauge may be able to identify missing, additional, and/or partial plies in a ballistic package. This may be accomplished at 103 by measuring and recording ply readings for samples that are known to be defective (red signal). The readings for the one or more packages that are known to be defective may be associated with the unique ID of the package or packages stored in the database. As noted above, the reading, readings, or any statistical derivation thereof may be a specific number, e.g., a set point, and/or a range representing lower and upper control limits.

Once calibrated, the gauge may be used to test samples having an unknown ply count or density. As discussed further below, the gauge includes at least one emitter and at least one detector. The emitter emits radiation from a radiation source and the detector is located relative to the emitter to receive the radiation. The gauge is generally operable to translate the level of radiation received or ply reading into a ply count or density in a ballistic material placed between the emitter and the detector. The level of radiation observed at the detector as compared to the level of radiation emitted at the emitter generally reflects the ply count of the package located between the emitter and detector for testing. Since the material or materials used in a given package have a common mass density, the system may reliably determine the thickness of a package based on the difference between the level of radiation emitted and the level received. In at least one embodiment, the radiation source generates ionizing radiation and the detector measures the number of particles generated that pass through the ballistic materials.

Testing generally involves placing the ballistic package between the beta radiation source and the radiation detector after a given package has been sewn. As noted above, any air bubble or gaps between plies should be removed before the package is tested. Thereafter, the system emits radiation in one or more pulses from the emitter, through the package, subsequently receives the radiation at the detector, and determines therefrom a ply reading that is translated into the thickness or the number of plies of the package at 104. In at least one embodiment, the gauge compares the ply reading with the calibration readings and determines therefrom whether the particular package satisfies the criteria for a good package and/or whether it satisfies the criteria for a bad package at 105. Based on whether the package is deemed good or bad, the system may allow the good package to proceed to the next manufacturing process 106-1, reject the bad package, trigger an alarm, and/or segregate it from the line at 106-2, send the bad package to be reworked to correct any defects at 107 and/or pass the reworked item to the line for assembly at 108.

The gauge of the present application may be used by operators manually or as part of an automated conveyor system. When used manually, the operator physically places a ballistic package between the emitter and detector of the gauge. In the automated system, a conveyor may feed the ballistic package to the gauge, a mechanical system may orient the package in a desired direction and remove gaps between the layers of the package, and the gauge may take the reading at one or more locations on the package. The system may also be able to detect a particular type of package being measured out of a plurality of different types of packages, e.g., using an input device, such as an alphanumeric keyboard, barcode reader, computer recognition technology, etc. The system may use information that identifies the type of package to select and apply testing criteria for the specific type of package being tested as opposed to other types of packages that the system may also be able to test. This allows the system to process multiple different types of packages without having to reconfigure the gauge after each use.

With regard to the manual operation, in addition to specific ply readings and any translation of the readings into a ply count or density, the gauge may be operable to generate an audio and/or visual pass or fail signal. For example, a red light may be displayed in respond to the system determining that the package being tested fails one or more criteria whereas a green light may be displayed in response to the system determining that the package being tested passes one or more criteria. In at least one embodiment, the ply reading at the detector is in an analog form. In this instance, the analog signal from the detector is converted into a digital signal that is usable by a computer interface. The computer interface allows the analog test data to be digitally captured, recorded, and/or compared with the calibration data stored in the database(s); calculates thickness or ply count of package therefrom; and/or displays readings with different color codes for good or bad packages (green code indicates good packages and red code indicates missing or additional ply(s) on package).

In addition to a single reading, the gauge may take several readings at different locations on a ballistic package. From these readings, a map of the ballistic package may be created that shows any variation in the thickness or ply count over the area of the package. These map readings may be compared with map data obtained from packages with known thickness or ply counts over the area of the packages. Map data associated with particular package IDs, such as a reading or range or readings, location or coordinates of each of the reading on the package, etc., may similarly be stored in the database. Thus, multiple maps may be stored and compared against various samples being tested. Multiple readings may be taken with a single emitter and/or detector, or a plurality of one or more the emitter and detector. In the former, the system may be operable to move the emitter and/or detector to take readings at the desired coordinates. In the later, an array of emitters and/or detectors may be located relative to each other to take readings at the desired coordinates so that multiple readings may be taken at one time or essentially simultaneously.

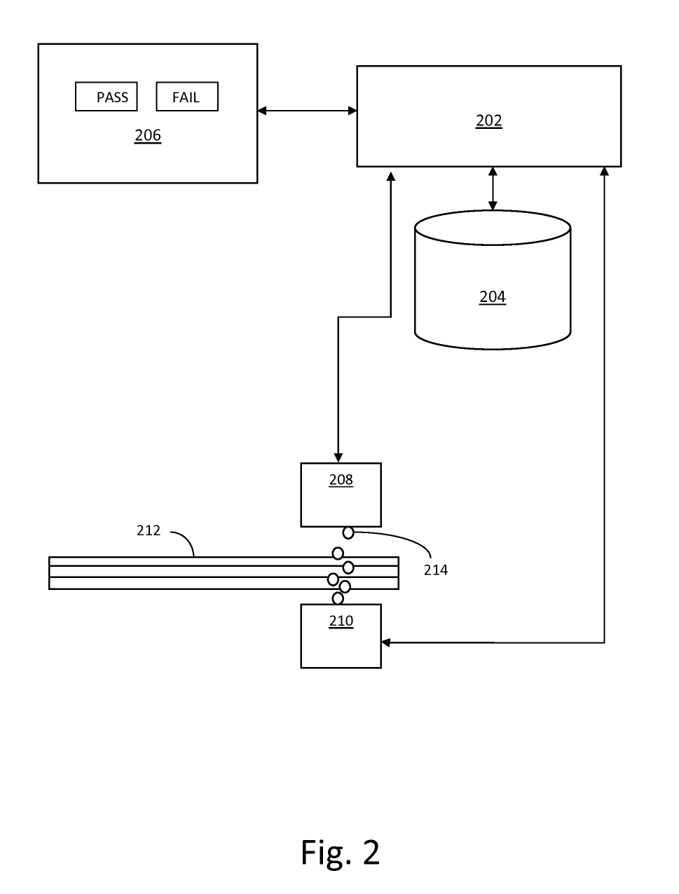

Referring to FIG. 2, the beta gauge or generally the system includes a radiation detector 208 and a radiation emitter and/or source 210 functionally coupled to a computing device 202. The computing device 202 has software associated therewith that when executed causes the computing device to perform one or more of the steps of the methods disclosed herein. The computing device 202 may further be coupled or otherwise associated with a database(s) 204, which may be used to store the information discussed herein, including the calibration data associated with particular ballistic packages. In certain instances, the computing device 202 may be coupled to a display 206 and/or at least one input device, such as a keyboard, mouse, touchpad, touch screen, barcode scanner, camera, etc., that provides an interface for operators to interact with the system and/or for the system to receive input in connection with testing ballistic packages.

The one or more emitters 210 generally emit particles 214 from the radiation source so that at least some of the particles 214 pass through the multilayer material 212 placed between the emitter 210 and the detector 208 and are measured with the radiation detector 208. The source and/or emitter 210 may be placed below the detector 208 to allow radiation to flow upward. The computing device 202 receives the reading from the detector and converts the pulse reading or readings from the detector 208. The converted reading may be used by the system for decision making, e.g., determining whether the package being tested fails and whether the failed package should be routed to be reworked, and/or to present an interface screen that provides a numerical value and/or a visual or audio signal for the one or more electronic pulses being detected by the detector 208.

Various types of sources may be used in the beta gauge, such as Promethium, Krypton, and Strontium, in order of their relative strengths as a beta source. The beta gauge works on the principle that fewer than all of the beta particles (fast moving electrons) emitted from the source become trapped in the plies of ballistic material. The particular material selected for the source is therefore the material having sufficient strength for a least a portion of the beta particles thereof to penetrate the package being tested. For example, Strontium may be used as a source to measure the number of aramid fiber plies in a ballistic vest or other item having, e.g., 34 or more plies of aramid fiber. Strontium should also be used when the power needed at the emitter is in the range of about 1000 to about 8000 g/m². Promethium-147 may be used up to about 300 g/m² and Krypton-85 to measure up to about 1800 g/m².

The amount of Strontium contained in the source is preferably 0.5 millicurie or 500 microcurie or more. Any less than 0.5 millicurie may not be effective for penetrating the number of layers of multiple layer ballistic packages needed to perform appropriately. Generally, the larger the size of the source material the more particles pass through the ballistic material being tested, which increases the accuracy of the measurement. Higher resolution radiation detectors may also be used that are capable of detecting more of the beta particles passing through the sample being tested.

Various types of radiation detectors may be incorporated into the gauge, including analog and solid state detectors. Solid state detectors have numerous advantages over analog detectors. The main difference between analog and solid state detectors is the type of semiconductor: gas vs. silicon, respectively. With regard to solid state detectors, beta particles from the emitter enter into the silicon region of the detector, which causes electrons to be released from the semiconductor material. The electrons released are observed with a pair of amplifiers distinguish, which produces the signal for the system to tally the electrons released and to translate the number of electrons into a ply count or density.

In at least one embodiment, ballistic Aramid or other multilayer material is placed between the emitter 210 and the detector 208. Beta particles travel out of the source, through our multilayer material, and into the radiation detector 208. For a more accurate measurement, the detector 208 should be placed between about 1 to about 4 inches from the source 210. The closer the detector is to the source the more beta particles can be detected, which may provide a more accurate measurement for ballistic applications. The time that the package is exposed to the source for testing may vary in this respect. The beta gauge may be capable of inspecting ballistic material moving at slow speed or stop for short time of period for testing. For example, the material may stop on beta radiation source for 4 seconds during which time particles that pass through the material are detected and counted, and moves forward to next station.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A method for determining a ply count of a multilayer material comprising:
placing the multilayer material between an emitter and a detector of a gauge;
emitting at least one pulse of ionized radiation from a source associated with the emitter;
detecting a number of particles emitted from the emitter passing through the multilayer material placed between the emitter and the detector; and
translating the number of particles detected into a ply count using a computing device.

2. The method of claim 1, wherein the multilayer material comprises a plurality of layers of ballistic material.

3. The method of claim 1, wherein the source comprises Strontium.

4. The method of claim 3, wherein the emitter comprises at least 0.5 millicurie of Strontium.

5. The method of claim 3, wherein the emitter emits radiation in a rage of about 1000 to about 8000 g/m².

6. The method of claim 1, comprising calibrating the gauge at least initially against one or more samples of a multilayer material having a known number of plies and storing calibration data comprising at least one of a set point, and an upper and lower control limit associated with the one or more samples.

7. The method of claim 6, comprising, for each of a plurality of lots of multilayer materials being tested, calibrating the gauge further by testing a set of samples from each of the lots against the initial calibration and storing calibration data comprising at least one of a set point, and an upper and lower control limit associated with the set of samples.

8. The method of claim 6, comprising determining that the multilayer material being tested is at least one of missing at least one ply, includes an extra ply, and includes a partial ply.

9. The method of claim 8, comprising displaying at least one of a visual and an audio indication that the material being tested has failed a test.

10. The method of claim 1, wherein the emitter comprises at least 0.5 millicurie of Strontium and wherein the emitter and detector are located from about 1 inch to about 4 inches from each other.

11. A system for determining a ply count of a multilayer material comprising:
an emitter operable to emit at least one pulse of ionized radiation from a source associated with the emitter;
a detector operable to detect a number of particles emitted from the emitter passing through the multilayer material placed between the emitter and the detector; and
a computing device coupled to at least the detector, the computing device operable to translate the number of particles detected into a ply count.

12. The system of claim 11, wherein the multilayer material comprises a plurality of layers of ballistic material.

13. The system of claim 11, wherein the emitter comprises at least 0.5 millicurie of Strontium and wherein the emitter and detector are located from about 1 inch to about 4 inches from each other.

14. The system of claim 13, wherein the emitter emits radiation in a range of about 1000 to about 8000 g/m².

15. The system of claim 11, comprising a database including calibration data comprising at least one of a set point, and an upper and lower control limit associated with one or more samples of a multilayer material having a known number of plies, the computing device operable to translate the number of particles detected into a ply count based on the calibration data.

16. The system of claim 15, the database further comprising calibration data for a set of samples of a lot of multilayer materials being tested, the calibration data comprising at least one of a set point, and an upper and lower control limit associated with the set of samples, the computing device operable to translate the number of particles detected into a ply count based on the calibration data associated with the set of samples of the lot.

17. The system of claim 15, the computing device operable to determine that the multilayer material being tested is at least one of missing at least one ply, includes an extra ply, and includes a partial ply.

18. The system of claim 17, the computing device operable to display at least one of a visual and an audio indication that the material being tested has failed a test.

19. A system for determining a ply count of a multilayer ballistic material comprising:
an emitter operable to emit at least one pulse of ionized radiation from a source associated with the emitter, wherein the emitter comprises at least 0.5 millicurie of Strontium;
a detector operable to detect a number of particles emitted from the emitter passing through the multilayer ballistic material placed between the emitter and the detector, and wherein the emitter and detector are located from about 1 inch to about 4 inches from each other;
a database comprising:
a first set of calibration data comprising at least one of a set point, and an upper and lower control limit associated with one or more samples of the multilayer material having a known number of plies, and
a second set of calibration data for a set of samples of a lot of multilayer materials being tested, the calibration data comprising at least one of a set point, and an upper and lower control limit associated with the set of samples; and
a computing device coupled to at least the detector, the computing device operable to translate the number of particles detected into a ply count based on the first set of calibration data and the second set of calibration data, determine therefrom that the multilayer material being tested is at least one of missing at least one ply, includes an extra ply, and includes a partial ply, and display at least one of a visual and an audio indication that the material being tested has either failed a test.
